(19) United States
(12) Patent Application Publication
(10) Pub. No.: US 2002/0092963 A1
(43) Pub. Date: Jul. 18, 2002

(54) Semitransparent sensor for steering an optical beam

(76) Inventors: Lawrence H. Domash, Conway, MA (US); Eugene Y. Ma, Brookline, MA (US); Adam M. Payne, Princeton, NJ (US); Matthias Wagner, Boston, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/000,146

(22) Filed: Oct. 19, 2001

Related U.S. Application Data
(60) Provisional application No. 60/241,805, filed on Oct. 19, 2000.
(60) Provisional application No. 60/241,737, filed on Oct. 19, 2000.
(60) Provisional application No. 60/246,866, filed on Nov. 8, 2000.
(60) Provisional application No. 60/252,106, filed on Nov. 20, 2000.

(51) Int. Cl. G01J 1/20

(52) U.S. Cl. 250/201.1

(57) ABSTRACT

An optical system including a steered beam, further includes a source of a light beam; a device which receives the light beam and steers it to form the steered beam; a target of the steered beam; and a semi-transparent sensor having an output signal indicative of a deviation of the steered beam from the target. A method of performing real-time control of an optical switch includes steering an optical beam onto a target within the switch; measuring a deviation of the optical beam from a nominal center of the target, while the optical beam is on the target; and correcting the direction of the optical beam to the nominal center of the target.

### CROSS-REFERENCE TO RELATED APPLICATIONS

This application claims the benefit of domestic priority to copending U.S. provisional patent applications Serial Nos. 60/241,805, 60/241,237, 60/246,866 and 60/252,106, filed Oct. 19, 2000, Oct. 19, 2000, Nov. 8, 2000, and Nov. 20, 2000, respectively.

### BACKGROUND

The present invention relates generally to optical devices and systems in which sensors are used to detect the position and/or direction and/or intensity of an optical beam. The invention relates more specifically to devices and systems characterized above and incorporated in devices and systems which steer an optical beam, for example for purposes of optical switching.

In the discussion that follows, an optical beam should be taken to be any beam of electromagnetic energy, transmissible through free space or other materials and components and which obeys the laws of optics as generally understood to the skilled artisan. Usually, such a beam will be a laser light beam in the infrared or near-infrared wavelength range, but other sources and wavelengths may be used in particular applications.

In the discussion that follows, optical switching means transparent optical switching. That is, switching of optical beams carrying information signals from an input waveguide, e.g. fiber, to an output waveguide, e.g. fiber, without converting the optical beam to a different form of energy. Since so-called opaque optical switches, i.e. those that convert the optical beam to a different form of energy such as electronic signal energy, do not involve beam steering as that concept is discussed below, they should be considered together with other, general optical systems mentioned below.

A short introduction to optical switching devices is now given because embodiments and aspects of the invention will be later illustrated in connection with such devices. The optical switches principally of interest here are microelectromechanical systems (MEMS). Optical switching devices can be divided into two main categories, two-dimensional (2D) switches and three-dimensional (3D) switches.

Conventional 2D switches (FIG. 1, 100) are useful for transferring optical signals between relatively limited numbers of input and output ports, e.g. 32 input and 32 output ports. The geometry of conventional 2D switches is fairly simple. A linear array of input ports 101 to which optic fibers 102 carrying input signals are connected and a linear array of output ports 103 to which optic fibers 104 carrying output signals are connected are arranged to produce light paths 105 that all lie in one plane, as shown in FIG. 1. Input signals emitted from the input ports are selectively directed into the output ports by an array of hinged mirrors. An activated mirror 106 connects an input port and an output port, while an inactivated mirror 107 does not. The input ports, output ports and mirrors are arranged in a fixed geometry that, once fixed by the device construction, does not require any sort of adjustment or monitoring over the life of the device. Initial alignment of these devices is critical but controlled during manufacture. Because the path length of different connections in a 2D switch varies, 2D switches are not readily scalable. The variation in transit time, phase, etc. becomes too great between different connections.

When larger numbers of input and output ports must be switched, then a known type of 3D optical switch, as shown in FIG. 2 or 3 may be used.

The input ports 301 of the switch 300 of FIG. 3 are arranged as an n×m planar array, and the output ports 302 of such a switch are arranged as a u×v planar array. The input and output arrays 301, 302 are conventionally square, and of equal numbers of ports. A beam 303 emitted by an input port 304 is directed onto a first dual-gimbaled mirror 305, a second dual-gimbaled mirror 306 and thence onto a selected output port 307.

Alternatively, as shown in FIG. 2, a single input/output array 201 could include n×m ports, each of which could serve as an input or an output, and each of which could be connected by the switch 200 to any other. An optical fiber 202 carrying an input signal or an output signal is connected to each port. Each port may include a microlens graded-index (GRIN) rod or other collimator 203, which is generally necessary to convert the diverging optical beams emerging from an optical fiber into a beam that propagates as parallel as possible through the required path of free space, within the limitations of diffraction, or conversely converts the parallel beams at the receiving end into the converging beam required to enter into an optical fiber efficiently.

In many 3D MEMS switch designs, each beam is reflected by a sequence of two mirrors, located in two different mirror planes, between the input port and output port. One mirror may be fixed and the other an array of articulated mirrors, or both planes may be articulated. In the latter example, there are four degrees of gimbal freedom to be adjusted, so that the beam is not merely aimed in angle, but adjusted for normal entry into the output collimator, for maximal efficiency. An optical beam 204 from an input port is directed to an arbitrarily selected output port by suitably controlling the orientation of two dual gimbaled mirrors 205 and one fixed mirror 206 onto which the optical beam 204 is directed.

In order to better understand the context of the embodiments and aspects of the present invention described below, it is helpful to understand the dimensions and other parameters of the various components of the conventional 3D optical switch.

Depending upon the particular application for the optical switch, different carrier frequencies may be used. The carrier frequency affects the design and construction of certain components, such as waveguide components, lenses and collimators. Two common carrier wavelengths, currently in use are 1310 nanometers for SONET systems and 1550 nanometers for wave division multiplex (WDM) systems. This difference in wavelength is significant, such that SONET compatible switches and WDM compatible switches may use different lenses, collimators, mirrors, etc., depending on performance specifications and path length.

The arrays of input ports and output ports adapt optical fibers to the switch, as discussed above. The optical fibers have core diameters of about 7-10 micrometers, and the fibers are spaced apart by about 1 millimeter. The input ports and output ports conventionally include microlens collimators that produce a collimated beam having a Gaussian diameter of about 50-1000 micrometers. The beam must be steered to the desired output port with a nominal accuracy of less than 1 micrometer of target center. The steering accuracy requirements may be analyzed in two domains, gross and fine.

In the gross domain, since the mirrors are freely gimbaled, and any port in the input plane may in principle be connected to any port in the output plane, a method is required for confirming that the beam is directed into the desired port, and not for example one adjacent to it or elsewhere in the output array. This is particularly challenging because in many 3D MEMS switch designs the beams may strike anywhere in the output region, even between output ports or away from the output array entirely, and if a beam is grossly misaimed for any reason, there may be no way of knowing where it is pointing. This level of aiming requires that a beam be directed with an accuracy of 0.3 mm over a pathlength possibly as long as 1000 mm (0.3 milliradians) with a field of regard up to 0.5 radian.

In the fine domain, once a given beam is aimed to the general proximity of the desired output port, it must be adjusted to couple the maximum amount of optical power into said port. This requires that the beam direction be controlled to approximately 10 microradians accuracy, over a field of regard of 300 microradians, requiring the optimization of 2-4 degrees of freedom of micromirrors, depending on whether the two planes of mirrors are both articulated.

The desired beam steering accuracy for most applications exceeds the capabilities of open loop systems. Therefore, closed loop systems have also been tried. Closed loop control calls for some method of detecting the beam position, without interfering substantially with the optical efficiency of coupling inputs to outputs. Most commonly, the amount of light coupled into an output port is used to ensure the accuracy of the beam steering. The mirror positions are dithered, and the signal coupled into the output port is maximized. This only works well if the beam is already fairly accurately on target. Another, less common method has also been tried. For example, H. Laor and others, have disclosed a method for sensing the beam position by an arrangement of optics and detectors provided in the output plane, as disclosed in one or more of U.S. Pat. Nos. 5,524,153, 6,097,858, 6,097,860, 6,101,299 or 6,236,481. Such discrete optical sensors are complicated, difficult to construct and package, and in any case sense the beam only at some and not all locations in the output port plane. Beam sensors are incorporated in the input/output port plane, between the input/output ports. Thus, when the beam deviates from the desired target sufficiently to illuminate one of the sensors, the error can be detected and consequently corrected. However, this system requires substantial deviation from target center before the error can be detected and corrected.

Another problem with conventional systems relates to the quality of, or presence of, the information signal on the optical beam at the time that beam steering must be performed is unknown. When an information signal is present on the optical beam, the information signal causes the beam intensity to vary as the information signal modulation is applied to the optical beam. Therefore, some conventional systems include a pilot beam of known characteristics in order to avoid a loss of control when the information signal varies or ceases.

### SUMMARY OF THE INVENTION

It is a general object of the present invention to provide improved optical systems and methods.

According to one aspect of one embodiment of the invention, an optical system including a steered beam, further includes a source of a light beam; a device which receives the light beam and steers it to form the steered beam; a target of the steered beam; and a semi-transparent sensor having an output signal indicative of a deviation of the steered beam from the target.

According to another aspect of an embodiment of the invention, a method of performing real-time control of an optical switch includes steering an optical beam onto a target within the switch; measuring a deviation of the optical beam from a nominal center of the target, while the optical beam is on the target; and correcting the direction of the optical beam to the nominal center of the target.

### BRIEF DESCRIPTION OF THE DRAWINGS

In the drawings, in which like reference designations indicate like elements:

FIG. 1 is a perspective view of a conventional 2D optical switch;

FIG. 2 is a perspective view of a conventional 3D optical switch having a first geometry;

FIG. 3 is a perspective view of a conventional 3D optical switch having a second geometry;

FIG. 4 is a perspective view of an array of sensors disposed on a transparent substrate;

FIG. 5 is a plan view of a single split-ring sensor;

FIG. 6 is a schematic drawing of a control circuit, which can be used with the sensor of FIG. 5, for example;

FIG. 7 is a cross-sectional elevation view of a single-segment sensor structure;

FIG. 8 is a plan view of the sensor of FIG. 7;

FIG. 9 is a cross-sectional elevation view of a multi-layer sensor structure;

FIG. 10 is a perspective view showing differential divergence of a beam comprised of two different frequency components;

FIG. 11 is a schematic drawing of a passive matrix output circuit; and

FIG. 12 is a schematic drawing of an active matrix output circuit.

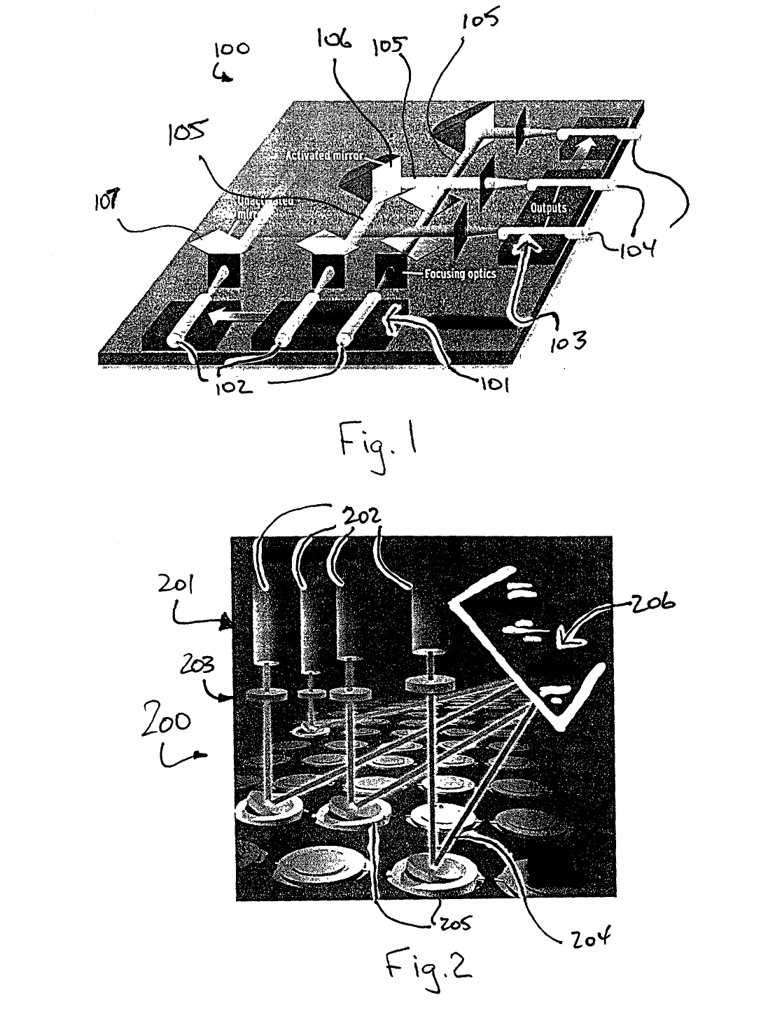

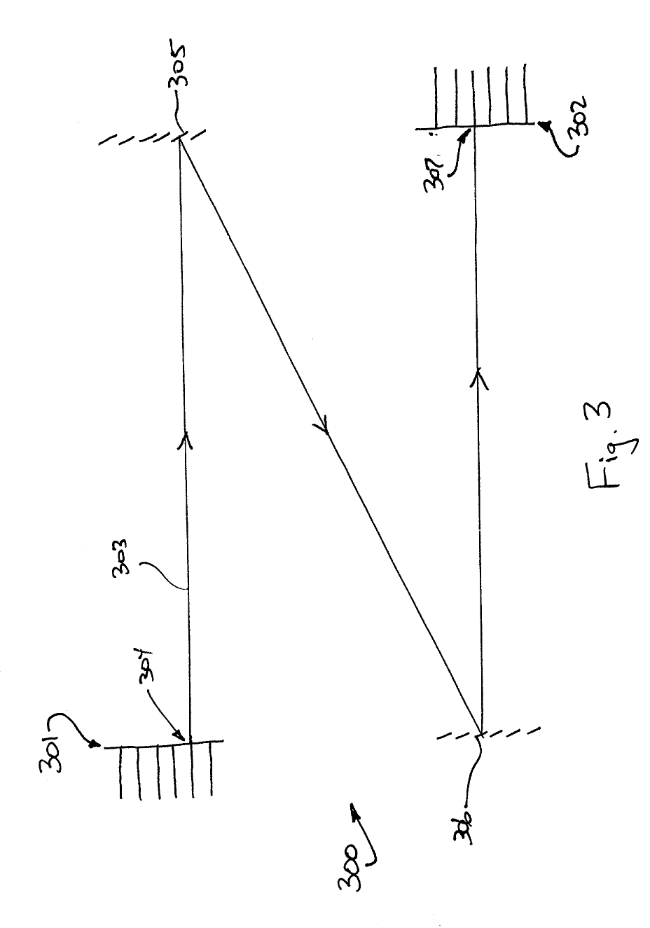

### DETAILED DESCRIPTION

The present invention will be better understood upon reading the following detailed description of various aspects and embodiments thereof.

According to one aspect of one embodiment of the invention, semi-transparent optical sensors are employed to detect beam steering errors in a closed loop beam steering system of a MEMS optical switch. Suitable semi-transparent films and sensor designs have been disclosed in U.S. patent applications Ser. Nos. 09/813,362, 09/813,447, 09/813,449, 09/813,450, 09/813,454, 09/813,455, 09,813,456 and 09/813,462, all filed Mar. 20, 2001 and incorporated herein by reference. The disclosed thin film optical detectors are semitransparent and may be freely patterned on a glass plate or other substrate, or on microlenses. These sensors allow the majority of the light to pass through, absorbing a small portion for sensing purposes, thus converting the surface of said substrate into a “smart substrate” or a lens or lens array into a “smart micro-optic” which measures the optical power passing through it. Such materials and designs are compatible with the materials and processes of MEM optical switches.

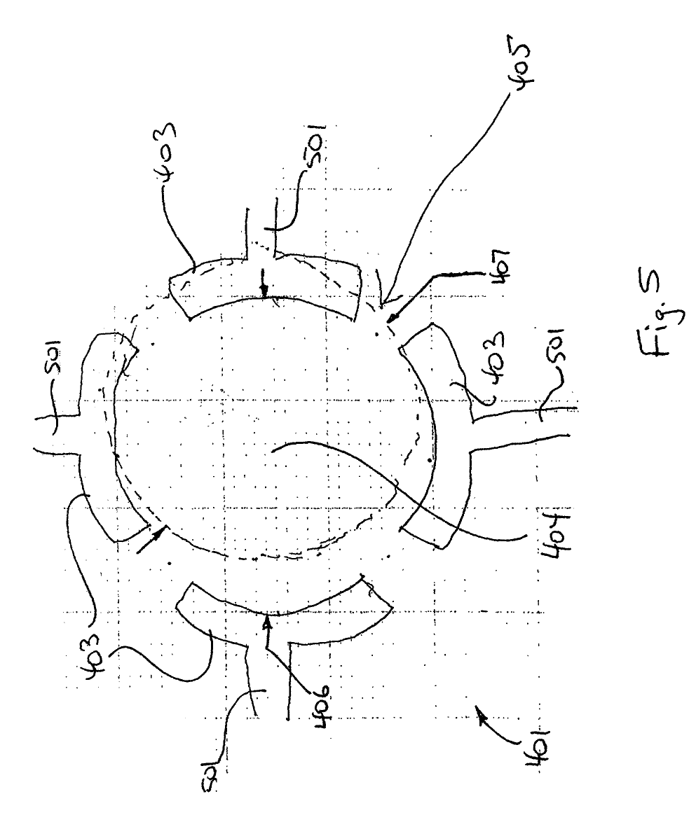

As shown in FIG. 4, an array 400 of semi-transparent sensors 401 can be positioned in the optical beam path near the output ports 402. The pattern of each individual sensor 401 is shown in FIG. 5.

Each sensor 401 comprises a pattern of film segments 403 having an unobstructed central region 404 of sufficient diameter to pass most of the optical beam 405, with three or more segments 403 placed around the unobstructed region 404 to sense the optical beam 405.

The unobstructed region 404 is provided to maximize the passage of data bearing light. Only a peripheral portion of the beam 405 is intercepted and partially absorbed by the sensor film segments 403. For example, if the diameter 406 of the unobstructed region 404 is equal to the diameter of the spot size 407, as that term is conventionally understood, of a beam having a Gaussian energy distribution, approximately 90% of the beam energy passes through the unobstructed region 404, while approximately 10% remains available for monitoring by the pattern of film segments 403.

As described in the patent applications mentioned above, the material properties of the semiconductor films of which the sensors are constructed can be selected and manufactured to obtain a desired absorbency and transparency at the wavelength of the optical beam. Insertion losses attributable to the sensor elements can be tailored to meet a total system loss budget, as desired. The skilled designer will be able to make a tradeoff between the magnitude of the feedback signal produced by the sensor system and the system loss budget.

Amorphous or polycrystalline films optimized for this application are known, and disclosed in the above-mentioned patent applications. By means of alloying, doping, multiple layers of varying compositions, and other process variations, three classes of sensors are feasible.

In the first class, a homogeneous film is deposited with a photoconductive response at the data wavelength. The conductivity of the individual segments shown in FIG. 5 is accessed by an arrangement of contacts 501 to each of the segments 403 on a first surface of the structures and to a common electrode (not shown) on a second surface of the structure. Each segment 403 produces a signal indicative of the amount of light falling on that segment. For example, the current flowing from a contact 501 through the corresponding segment 403 to a lower contact (not shown) may vary with the amount of impinging light. The centering of the optical beam is then detected by a bridge circuit connecting the segments 403 at opposite sides of the unobstructed region 404 to provide a pair of null signals corresponding to the two degrees of freedom of a beam steering micromirror that can be used as part of an active feedback loop to control fine positioning of said micromirror. In this case however, no power monitoring function will be available because an unknown portion of the fringe of the beam is all that the sensor elements intercept.

A second class of film structures is deposited in layers as PIN photodiodes by means of which the intensity of the optical beamlet is detected directly. Each segment is biased by an applied voltage and the photocurrent measured. Again, a combination of currents from the several segments is balanced in a bridge or similar circuit in order to provide two electrical signals proportional to the centering of the optical beam in two directions corresponding to the action of the micromirrors in use.

A third class of film structures, phototransistors, can also serve the sensor purpose. In this application, response speeds on the order of milliseconds, available in the referenced film structures, are adequate for the purposes of mechanical feedback control. Standard methods of lithography are widely practiced for the patterning of the sensor segments to the required level of precision, approximately 1 micrometer. In the case of photodiodes or phototransistors, power monitoring in addition to position sensing may be possible depending on the sensor geometry.

Because the referenced thin film semiconductors can be deposited at relatively low temperatures, directly upon sensitive devices or materials, other embodiments are possible whereby the sensitive films are fabricated directly onto the collimator array, without an intervening transparent plate, or onto other structures which may be presented by particular cases of 3D MEMS switch designs. Thus the method has sufficient flexibility to be integrated into the design of many different 3D optical MEMS crossconnect switches, through nondestructive processing steps compatible with the fabrication of the switching device.

The exemplary embodiments described throughout use any of the sensors discussed above, which may be deposited directly on optical components, including even plastic, and can therefore be directly integrated with the output plane optics of a beamsteering system, such as an optical switch. For beam-steering systems in optical communications equipment the output plane generally consists of a plane of beamfocusing or collimating elements that concentrate wide beams into optical fibers. These planar elements are particularly compatible with the processes discussed in the abovenoted patent applications, which rely on large-area material deposition techniques, such as plasma-enhanced chemical vapor deposition and sputtering, and standard photolithographic techniques. In addition, these materials can be deposited on curved surfaces such as refractive microlenses, and even on diffractive elements.

In this exemplary sensor design, the beam position is detected by comparing the conductivity of each of the sensor segments. As mentioned above, the sensor segments may be connected to a bridge circuit, whereby a pair of null signals identifies a centered beam. The output of the bridge circuit can be used as an error signal in an active feedback loop to control the fine positioning of a beam steering mirror.

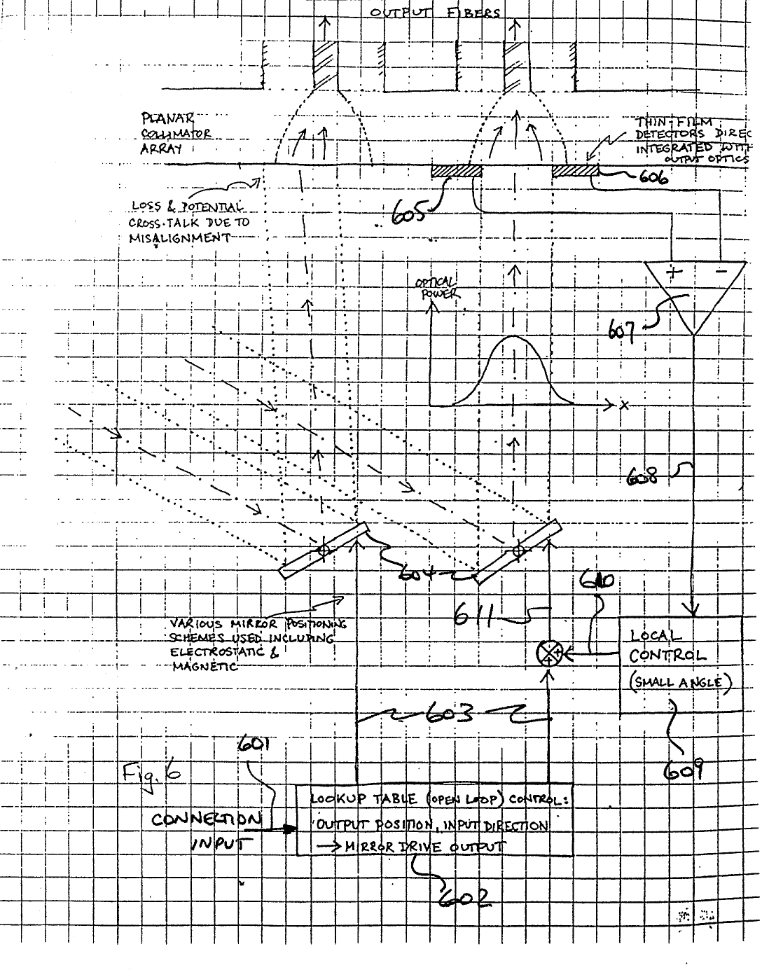

Next, a complete closed loop beam steering control for a transparent optical switch is described in connection with FIG. 6.

This system may be integrated easily with current open-loop control systems that rely completely on a “lookup-table” system where a desired connection is received as a command input 601 and is translated by a look-up table 602 into a control signal 603 for the beam-steering element, e.g. mirror 604. Some of these systems monitor the position of the beam-steering element, e.g. mirror 604, locally, but small errors in the beamsteering element position may translate into large variations at the output due to the long free-space paths involved in these systems. In a MEMS-based steering system, for instance, a tiny variation in the mirror deflection angle due to minute vibrations or temperature variation may be below the resolution of an integrated MEMS monitoring system, but may be quite evident from direct monitoring of beam alignment as it falls on the output plane.

This closed loop system is a so-called “local” control system for beam steering that provides closed-loop control around a particular beam output position. Within such a small range, it is much more likely that the system behaves in a linear manner than across large changes required for output-to-output changes. This means that rough beam steering for selecting a particular path may be done using a fixed look-up table 602, and the following system can provide extremely precise control of the beam, once it is locked into a particular output position.

It is advantageous if the system of aiming can accommodate both the gross and fine control levels by the same method.

According to the described aspects of embodiments of the invention, both coarse and fine positioning are measured and can be controlled. Sensors with plural segments 605, 606, as discussed above, measure fine position as discussed above. Such sensors may extend beyond the edges of the output port with which they are associated, and are thus able to provide position information even when the beam is considerably displaced from the target position. The sensor elements 605, 606 can be made to extend well beyond the edges of the output port with which they are associated. Sensors with a single element covering plural output ports, described below, provide even better coarse position measurement because such a sensor provides measurement information even when the beam is at locations very remote from the target or from any output port.

The exemplary system is based on differential measurements on 1 or 2 axes, depending on the exact configuration of the beam-steering system, which may be accomplished using 2-4 sensors. Three sensors are theoretically sufficient for 2-axis control, but require somewhat more complex processing electronics/software. A differential measurement gives best control, and also eliminates certain sensor-specific variations that may occur, e.g., dark current, as the sensors are fabricated very close to each other on the same substrate. Temperature-induced variations in dark current in a PIN photodiode, for example, will cancel in such an architecture. For even higher accuracy, sensors may be calibrated at the time of assembly to calculate offset and scaling levels.

After offsets and scaling factors are applied to sensor output levels, they are compared 607 to calculate the axis-specific signal 608. This signal 608 is used to drive the local control system 609. The local control system 609 may be of various forms, and may be an adaptive control system that is situation-dependent, i.e. the control system applied during switching may be different than during steady-state operation. For local control, a linear control system such as a conventional proportional-integral-differential (PID) control scheme will usually suffice. For a MEMS micromirror system, for instance, the span of this control will generally fall into the “small angle” regime where a linear analysis is applicable. More sophisticated controls applicable to non-linear regimes may be applicable to short-timescale control for switching. During switching a specific system for reducing “settling time” is desirable. The local control 609 produces an output signal 610 which may be simply added to control signal 603 to produce the mirror drive signal 611.

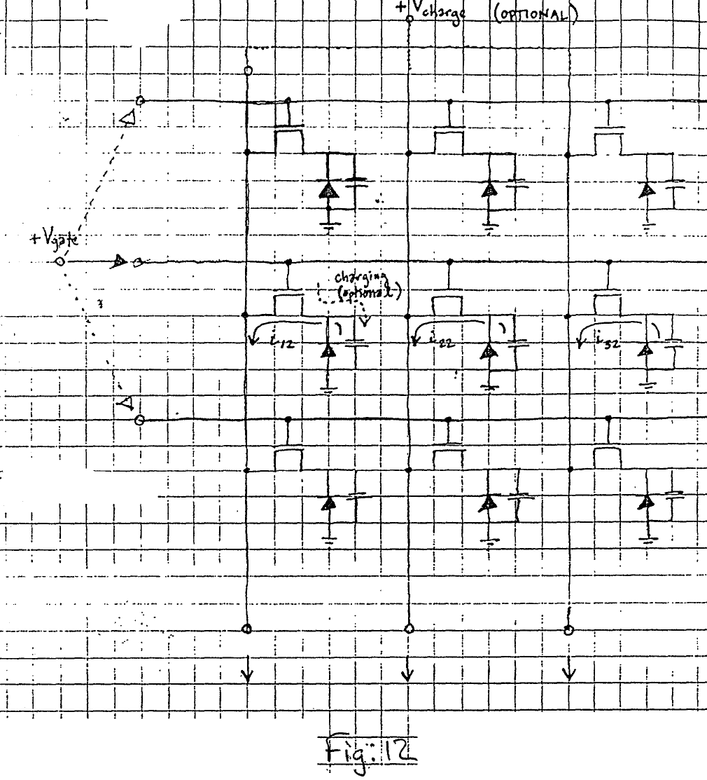

An example of this system is depicted in FIG. 6. For large arrays of outputs and sensors, it may be preferable to use a matrix-readout that is either passive or active. Examples of these, respectively, are shown in FIGS. 11 and 12. An active matrix may allow the highest resolution as well as a built-in “integrating” function that builds signal strength while electronics read out other sensors.

In addition, for higher sensitivity it may be desirable to implement a control system that uses dithering to introduce deliberate slight perturbations in the beam path. These perturbations are in turn picked up by the sensors, and are correlated with the dithering signal in the control electronics, in effect creating a “lock-in amplifier” which can provide even higher signal and control accuracy.

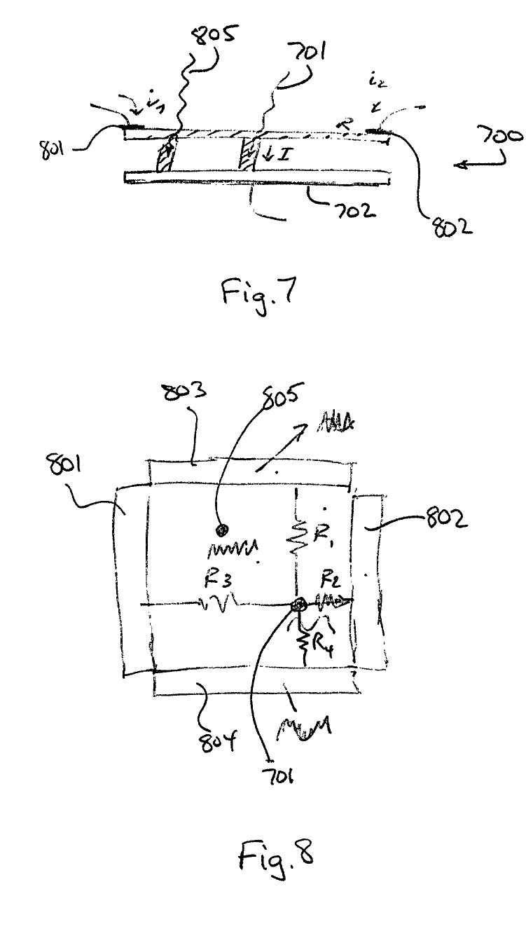

A single segment sensor, having no unobstructed region, as shown in FIGS. 7 and 8, is also possible. Such a sensor detects induced current I due to a light beam 701 passing through the sensor structure 700. In this type of sensor, the entire open area of the sensor is sensitive to the impinging light, as compared to the individual segments 403 of the sensors of FIGS. 4 and 5, which only intercept fringes of the impinging beam when it is centered. Due to the different resistive path lengths R₁, R₂, R₃, R₄ from electrodes 801, 802, 803, 804 disposed at opposite edges of the sensor material, different current flows are observed through the four electrodes, depending upon the beam position. Looking at the plan view of FIG. 8, it can be seen that the position of the light beam in two dimensions is fully determined by the distribution of current flows in the peripheral electrodes 801, 802, 803, 804, which are combined in current flow I through the common electrode 702. A minimum of three electrodes is required to fully determine the position of the light beam. However, it is mathematically simpler to compute the position of the light beam based on a four or five electrode structure. The total current flow I can be used to determine the beam strength.

Because the entire beam passes through the above-described single segment sensor structure, the structure can be used to measure beam intensity as has been described in the above-mentioned patent applications, as well as position. Moreover, the single segment structure may be made large enough to cover plural input/output ports of a 3D MEMS optical switch, enabling the control system to obtain feedback during both coarse and fine positioning steps, as a beam is first steered towards a desired port and then centered on the desired port. This structure, system and method is particularly useful in connection with a pilot signal as explained below.

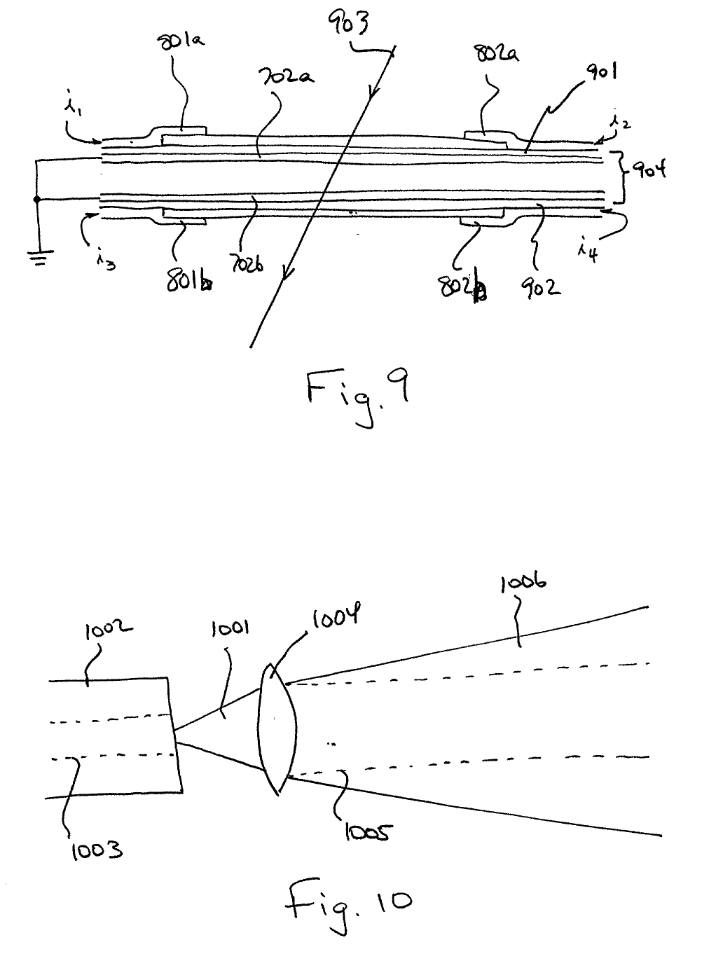

In some optical systems, it may be desired to measure the angle or direction of an optical beam, as well as its position and intensity, as it crosses a measurement plane. Such systems can use the structure of FIG. 9, in which two of the single segment sensors of FIGS. 7 and 8 are disposed on parallel planar supports 901, 902. Peripheral electrodes 801a, 802a and common electrode 701a cooperate with support 901 to form one sensor, while peripheral electrodes 801b and 802b, and common electrode 701b cooperate with support 902 to form a second sensor. As the beam 903 passes through this composite structure, the intensity, position and direction of the beam can be measured. Intensity and position at each of the measurement planes can be determined as discussed above. The direction of the beam is determined using simple linear algebra, given position measurements on the two measurement planes spaced a known distance 904 apart.

In some 3D optical switches, the beam is directed by two mirrors from an input port to an output port. Because two mirrors provide more degrees of freedom than one mirror, it is possible in such a switch to perfectly center the beam on the output port target, but for the beam to have an angle of incidence on the output port that does not optimally couple the beam into the output port. It is in this type of structure, for example, that the foregoing multi-layer structure can be useful because both the position and the angle of the beam can be measured. A closed-loop feedback control system can then adjust both mirrors to optimize both position and angle of the beam.

The sensors described above can be integrated with any transparent optical component of the system in which the sensors are used. For example, the sensors can be integrated with a protective window, integrated with a lens element or integrated with a collimator, as may be required. Moreover, as discussed in the patent applications noted above, the materials of which the sensors are constructed are compatible with processes currently used for manufacture of optical components. Therefore, the sensor materials can be integrated directly with the other transparent and opaque optical elements of such systems, including, but not limited to, waveguides, detectors, mirrors, lenses, windows, passivation layers, etc.

Feedback control systems are more accurate, stable and readily designed when the signal measured is of high, steady quality. Since the information carrying signal on the optical beam may be modulated, intermittent, or otherwise of unstable quality, it is preferable to control the beam steering apparatus on the basis of a known, high-quality pilot signal included in the optical beam, as now described.

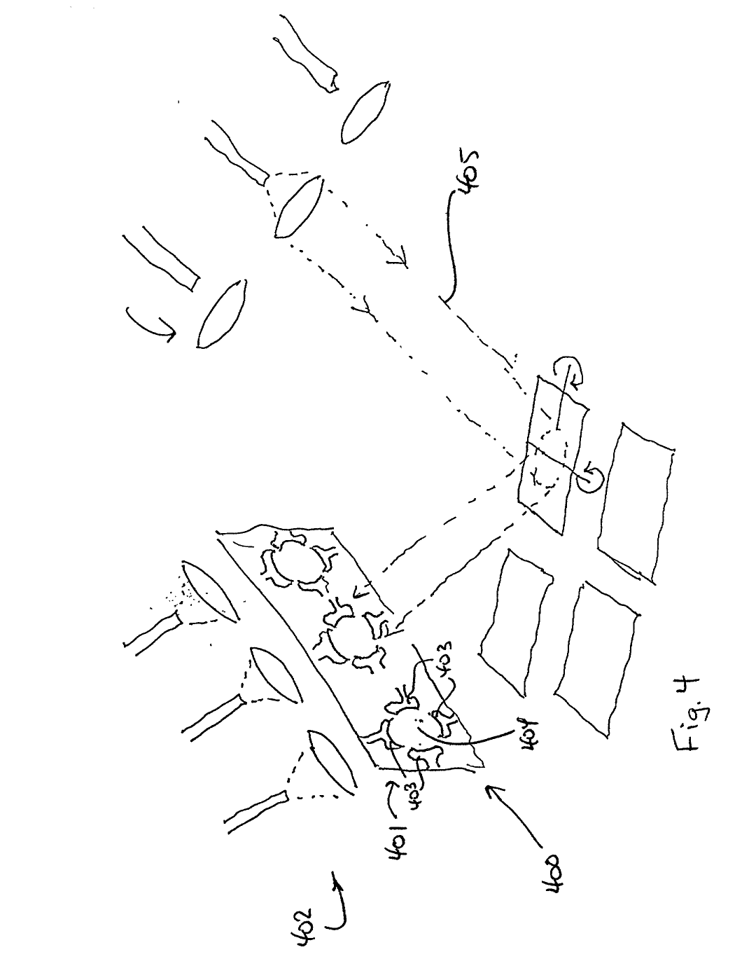

In an aspect of an embodiment of the invention including a pilot signal, 1310/1550 nanometer “coarse WDM” multiplexer/demultiplexers are placed in the path of every fiber downstream and upstream of the switch. The switch is configured as shown in FIGS. 3-6, for example.

In this exemplary embodiment, the data wavelength is 1550 nanometers and the pilot wavelength for position monitoring is 1310 nanometers, which, as noted above, may be added to the optical fibers by means of commonly available 1310/1550 WDM devices. Because 1310 nanometer light, propagating in an optical collimation and beam steering system designed for 1550 nanometers, will necessarily be imperfectly collimated and will possess a larger beam divergence and hence larger diameter at the output collimation plane than the 1550 nanometer beam diameter, it will be possible to sense said 1310 nanometer beam while most of the 1550 nanometer beam passes through the central aperture. If the input collimators are refractive, for example involving lenses and/or graded index rods, a moderate difference in divergence angle will result. If the input collimators are diffractive, a relatively larger difference in divergence will result. Other data and pilot beam wavelengths are, of course, possible. The same principle will apply if the data wavelength is other than 1550 nanometers, provided a pilot beam wavelength is chosen bearing a similar relationship as described above.

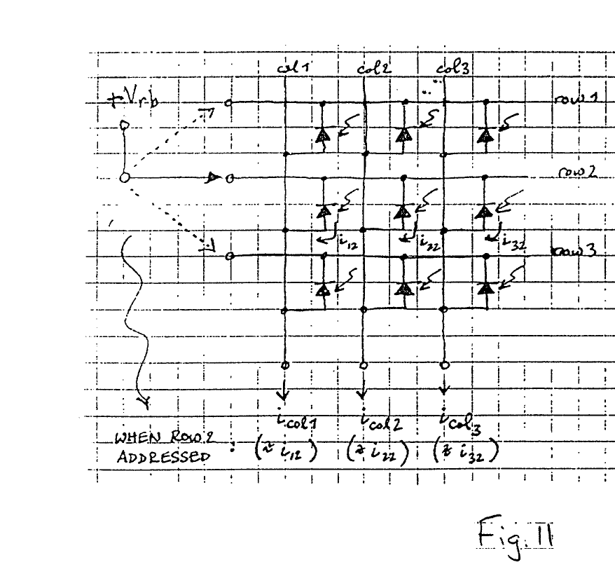

FIG. 10 illustrates differential divergence as follows. A beam 1001 exits an optical fiber 1002 having a core 1003. The beam 1001 then passes through a collimator 1004, which produces collimated beam 1005. Any part of the beam 1001 possessing a wavelength shorten than that for which the collimator 1004 was designed, diverges 1006.

In addition, if the material of the sensor films is chosen to be sensitive to 1310 nanometers wavelength, but substantially transparent to 1550 nanometers, as is described in the patent applications noted above, a second method is thereby available to sense the management wavelength while passing the data wavelength substantially unaffected. By virtue of these two methods, the central aperture taking advantage of the difference in beam divergences at 1310 nanometers and 1550 nanometers, and secondly the relative transparency of the sensor films at 1550 nanometers, the losses at 1550 nanometers caused by the beam steering subsystem are minimized.

These two methods can be used independently or in combination, depending on the available sensor film properties, the level of feedback signal required, and the specifics of the optical switch design. For example, a relatively large central aperture can be designed to pass most of the data wavelength signal even if the film is relatively absorptive at the data wavelength. Alternatively, if the film is sufficiently transparent at the data wavelength to meet the needs of a particular network architecture a loss budget, the clear aperture could be of small radius or eliminated entirely, resulting in a larger feedback signal for mirror steering.

The large single segment structure described above that covers plural, perhaps all, input/output ports of a 3D MEMS can be advantageously used together with the pilot signal just described, as follows. A first method uses one pilot signal that is selectively switched into a beam to be steered. A second method uses plural pilot signals that are carried by plural beams simultaneously.

According to the first method, the structure may be made of a material more sensitive to the wavelength of the pilot signal and more transparent at the wavelength of the data signal. The pilot signal is injected into the beam of the input desired to be switched or whose position at an output port is desired to be finely positioned.

According to the second method, the sensitivity and transparency of the material may be similar to the first method, but plural distinct pilot signals may be used, as follows. Each pilot signal may be at a distinct wavelength, distinguishable by the sensor from each other pilot signal. Alternatively, each pilot signal may be modulated by a distinguishing tone or other signal. The different pilot signals may therefore be separated and their positions distinctly determined.

As seen in FIGS. 7 and 8, light beams 701 and 805 carry pilot signals either at different wavelengths or having different modulation. Thus, the high frequency currents produced by the different beams can be separated by conventional signal processing techniques and the positions of beams 701 and 805 separately, but simultaneously measured.

The benefits of the closed loop system and sensors described herein include but are not necessarily limited to:

1. Superior repeatability. Local control enables better repeatability of output coupling from port to port, and also on the same port over time, since all minor variations in steering or system mechanics may be compensated for.

2. Superior coupling. Better coupling may be achieved on every switch, and this coupling may be maintained over long periods of time; in many cases this also means less backreflection from the output plane, which both decreases reflections into the input fibers, but also reduces crosstalk between output channels.

3. Early failure warning. The sensor system disclosed may provide early warning of mechanical or electrical failures as they grow worse over time, far before a total failure on the output; in effect the system is able to monitor degradation in the beam-steering system. It should be noted that this is not limited to alignment: beam width, i.e. dispersion, may also be monitored with the same sensors to provide early warning of mechanical changes in the system, such as changes in distances, or possibly warping of micromirrors, etc.

4. Faster settling time. Overall faster switching time may be achieved with proper control systems and large-area sensors, whether single-segmented or multiple-segmented. A standard PID control system, for instance, provides “damping” that decreases settling time. A more sophisticated control system could be implemented specifically for the purpose of speeding up switching times, a major benefit for optical communications systems. Large-area sensors provide better information for controlling gross beam movements.

5. Compensation for temperature and vibration-induced effects. A system like the one proposed will help compensate for temperature-induced mechanical or refractive index changes which may occur locally on the input or switching planes. In addition, the proposed system may compensate for errors induced by vibrations or system handling, potentially reducing the size, weight, and facility requirements for these systems. If a very high-speed readout system is introduced, the disclosed control system may even be able to compensate for vibrations in real time.

All the above elements combine to make a control system based on thin film semiconductor sensors an extremely attractive one for manufacturers of beam-steering switches. The economic and product benefits are clear: (1) lower manufacturing and assembly accuracy may be required, lading to higher yields and lower manufacturing and packaging costs; (2) the system may be made self-calibrating, so the painstaking calibration process is effectively removed form the manufacturing process; (3) the switches become extremely reliable, and when failures occur, advance warning is given in many cases; (4) packaging and facility requirements become less severe, potentially allowing more advanced technologies to penetrate smaller systems; (5) very little additional packaging or components assembly is required since the feedback sensors are integrated directly with optics already present in most systems.

The result for optical communications switch manufacturers, for instance, will be the ability of offer products in markets such as metro-area or even high-bandwidth access that have not benefited from many of the most sophisticated all-optical switching technologies available today. In addition, our system may dramatically accelerate the product lifecycle in MEMS-based optical switching, where much of the work goes into packaging and systems added to insure stability.

Variations of the disclosed system can include, but are not limited to:

local processing on sensor plane to compute axis differentials, or even to produce integral, time differential, or other signals locally for read-out;

mounting CMOS readout and control circuitry directly on the micro-optical substrate, on the same plane with the thin film semiconductor sensors, to provide a minimum number of output lines from the output plane back to the beam steering system;

systems that can switch from “general scan” mode to ensure steady operating parameters to “switch mode” that scans signals from a particular output cell at a much higher rate or even continuously to minimize settling time and lock the beam steering system into an optical coupling position;

additional thin film semiconductor sensors interspersed between output locations to assist during the switching process, again, to optimize switching of beam-steering elements to minimize switching time; these sensors may also be used to sense general light level in enclosure and thereby monitor potential of cross-talk;

semitransparent power sensors integrated at each output location to allow measurement not only of alignment, but to provide very accurate information on channel power level;

the use of a separate pilot signal for such an alignment system to which thin film photodetectors are sensitive; this pilot signal may either be in the same band as the information carrying signal of the beams, or in a different band altogether; this pilot signal may be pulsed in order to provide signal lock-in for higher system sensitivity;

the incorporation of a separate sensor plane, not the output plane, in conjunction with a separate monitoring optical source to verify and control micro-mirror position from an off-angle system, i.e. use mirror to reflect both the main path, but also a separate monitoring path that is not directly integrated but nevertheless uses long beam paths to amplify any errors in mirror positions;

the incorporation of sensors onto input plane optics that allow power and beam width monitoring at the input, providing information on beam degradation from input to output during manufacturing and operation, further increasing self-calibration/assembly-aiding and early failure warning capabilities of the system; sensors on the input plane, either semitransparent or very small aperture relative to total beam size, can provide information on beam power, beam shape, and even wavelength if required;

feedback from the sensor plane to temperature or direct mechanical controllers to modify bulk characteristics of the beam steering plane, for example, thermal expansion may introduce a bulk error into the system that would produce regular beam offsets at outputs; the same system may be used during assembly to provide alignment guides, which is faster than monitoring outputs, which provide only intensity, and not assignment feedback; and

the use of the disclosed sensors, systems and methods during the assembly of MEMS switches or other optical devices in which an optical beam traverses free space and must be aligned with another component of the system to measure alignment and provide feedback for manual or automatic alignment processes.

The present invention has now been described in connection with a number of specific embodiments of aspects thereof. However, numerous modifications, which are contemplated as falling within the scope of the present invention, some of which have been described above, should now be apparent to those skilled in the art. Therefore, it is intended that the scope of the present invention be limited only by the scope of the claims appended hereto.

What is claimed is:

1. An optical system including a steered beam, comprising:
a source of a light beam;
a device which receives the light beam and steers it to form the steered beam;
a target of the steered beam; and
a semi-transparent sensor having an output signal indicative of a deviation of the steered beam from the target.

2. The system of claim 1, further comprising:
a portion of the sensor overlying the target.

3. The system of claim 2, the source of the light beam further comprising:
a pilot signal source, whereby the light beam has an information carrying portion and a pilot portion.

4. The system of claim 3, wherein the pilot portion of the signal is carried on a first wavelength and the information-carrying portion of the signal is carried on a second wavelength, and wherein the sensor further comprises:
a sensor film that is more transparent at the second wavelength than at the first wavelength, and that is more sensitive to the first wavelength than the second wavelength.

5. The system of claim 2, further comprising:
a second sensor overlying the first sensor, whereby both position and direction of the beam are measured.

6. The system of claim 2, further comprising:
an optical switching element through which the beam passes, wherein the target is one of plural targets within the optical switching element.

7. A method of performing real-time control of an optical switch, comprising:
steering an optical beam onto a target within the switch;
measuring a deviation of the optical beam from a nominal center of the target, while the optical beam is on the target; and
correcting the direction of the optical beam to the nominal center of the target.

8. The method of claim 7, further comprising:
combining an information signal with a pilot signal to form the optical beam.

9. The method of claim 8, further comprising:
modulating the pilot signal to distinguish it from the information signal.

10. The method of claim 8, further comprising:
emitting the pilot signal at a different frequency than the information signal to distinguish it from the information signal.

11. The method of claim 8, including a first optical beam and a second optical beam, further comprising:
distinguishing the first optical beam from the second optical beam by modulating a first pilot signal differently than a second pilot beam modulated on the second optical beam.

12. The method of claim 7, further comprising:
detecting when the optical beam leaves the target center.

13. The method of claim 7, further comprising:
measuring a position of the optical beam as a continuous signal.
